(19) United States
(12) Patent Application Publication
(10) Pub. No.: US 2016/0017567 A1
(43) Pub. Date: Jan. 21, 2016

(54) ACCESS DOOR

(71) Applicant: Maxam Metal Products Limited, Burnaby (CA)

(72) Inventors: David R. WISE, New Westminster (CA); Kim Thomas Sefton BAND, Surrey (CA)

(21) Appl. No.: 14/800,285

(22) Filed: Jul. 15, 2015

Related U.S. Application Data
(60) Provisional application No. 62/025,330, filed on Jul. 16, 2014.

(51) Int. Cl. E02D 29/14; E06B 7/28; E06B 5/00

(52) U.S. Cl. CPC E02D 29/1427; E06B 5/00; E06B 7/28

(57) ABSTRACT

A clip-in access door for covering an opening in a construction surface has a frame for mounting in the opening, a door mounted on the frame, and a plurality of clips mounted on the frame for securing the frame in the opening of the construction surface. The clips along at least one edge of the frame are rotatable between an insert position and a lock position. Methods of using the clip-in access door are provided.

### REFERENCE TO RELATED APPLICATIONS

This application claims the benefit of U.S. provisional patent application No. 62/025,330 filed 16 Jul. 2014, the entirety of which is hereby incorporated by reference herein for all purposes.

### TECHNICAL FIELD

Some embodiments of the present invention relate to access doors for use in providing access to functional building components behind finished surfaces such as walls or ceilings. Some embodiments of the present invention relate to methods of using such access doors.

### BACKGROUND

In building construction, it is often necessary to provide ready access to spaces containing functional building elements behind finished surfaces such as walls and ceilings. For example, access may be required to reach plumbing fixtures, valves on water lines, meters on gas lines, electrical fixtures, switches, circuit breakers, or the like positioned behind a finished building surface such as a wall or ceiling.

Typically, access is accomplished by providing an opening in the finished surface and inserting an access panel that can be removed or an access door that can be opened in the opening. The access panel or access door provides access to the space behind the opening. In situations where the access panel or access door is regularly viewed by persons within the building, the access panel or access door may also provide an aesthetically pleasing look consistent with the finished surface.

To provide access to the space behind the opening, an access panel must be removed. After the necessary work has been completed, the access panel must be placed back in the opening. In contrast, the door of an access door can simply be opened to provide access to the space. After the necessary work has been completed, the access door can be secured in the closed position.

A typical access door has a frame that is installed in the opening of a finished construction surface. The frame supports a door mounted thereon with hinges, so that the door can be moved between a closed position covering the opening and an open position allowing access through the opening. A typical access door also includes a latch or lock mechanism, which allows the door to be secured in the closed position.

Installation of typical access doors is slow and cumbersome. Some access doors are installed using screws or nails fastened through apertures provided in an internal flange of the frame. In some cases, adhesives and/or caulking may be used to secure the access door in place. Furthermore, once installed, typical access doors cannot be readily removed. This presents additional difficulties, for example if the construction surface in which the access door is located needs to be refinished.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a clip-in access door for covering an opening in a construction surface. The access door has a frame for mounting in the opening, and a door mounted on the frame. The door is moveable between a closed position covering the opening and an open position allowing at least partial access through the opening. A plurality of clips are mounted on the frame for securing the frame in the opening. The clips along at least one edge of the frame are rotatable clips that are rotatable between an insert position allowing the frame to be inserted fully into the opening without substantial interference by the rotatable clips and a lock position securing the frame in the opening. In some embodiments, the rotatable clips have a curved clamping portion.

A further aspect of the invention provides a clip-in access door for covering an opening in a construction surface. The access door has a frame for mounting in the opening, and a door mounted on the frame. The door is moveable between a closed position covering the opening and an open position allowing at least partial access through the opening. At least two clips are mounted on the frame for securing the frame in the opening. A first one of the at least two clips is mounted on a first edge of the frame and is a fixed clip. A second one of the at least two clips is mounted on a second edge of the frame opposite the first edge and is a rotatable clip that is rotatable between an insert position allowing the frame to be inserted fully into the opening without substantial interference by the rotatable clips and a lock position securing the frame in the opening. In some embodiments, the rotatable clip has a curved clamping portion.

A further aspect of the invention provides a method of installing a clip-in access door in an opening in a construction surface. A first edge of a frame of the access door bearing at least one clip is inserted over a clamping surface of a corresponding first edge of the opening so that the clip engages with the clamping surface. A second edge of the frame of the access door bearing at least one rotatable clip is inserted over a clamping surface on a corresponding second edge of the opening, with the rotatable clip being rotated to an insert position. After the access door is positioned, the rotatable clip is rotated from the insert position to a lock position so that the rotatable clip engages a clamping surface on the second edge of the opening to secure the clip-in access door in an installed position.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a front view of a schematic representation of a clip-in access door according to one example embodiment.

FIG. 1B is a perspective view of a clip-in access door according to an example embodiment with the door in the open position.

FIG. 1C is a rear view of an example embodiment of a clip-in access door with the rotatable clips in a locked position.

FIG. 2 is a cross-sectional view of an example embodiment of a clip-in access door installed in an opening of a construction surface.

FIG. 3 is a side view of an example embodiment of a fixed clip for use in some embodiments.

FIG. 4 is a side view of a second example embodiment of a fixed clip for use in some embodiments.

FIG. 5 is a side view of an example embodiment of a rotatable clip for use in some embodiments.

FIG. 6 is a schematic diagram showing an example embodiment of a rotatable clip in exemplary insert and lock configurations.

FIG. 7 is a cross-sectional view of an example embodiment of a clip-in access door showing details of the hinges used to secure the door to the frame.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used in this specification, the term “inwardly” means in a direction towards the centre of the clip-in access door. The term “outwardly” means in a direction away from the centre of the clip-in access door.

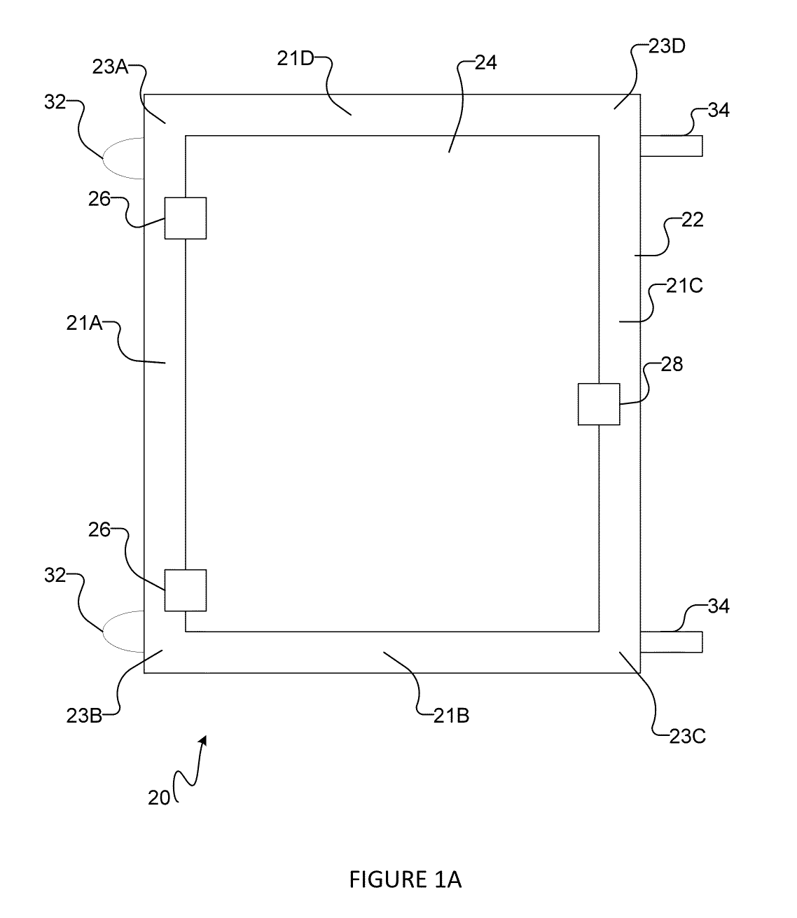

With reference to FIG. 1A, an example embodiment of a clip-in access door 20 is schematically illustrated. Clip-in access door 20 has a frame 22 and a door 24. Door 24 is secured to frame 22 via hinges 26, which allow door 24 to be moved to an open position with respect to frame 22 to provide access through an opening 29 in a construction surface 30. A securing mechanism 28 is provided to releasably hold door 24 in a closed configuration with respect to frame 22, covering the opening 29 in a construction surface 30.

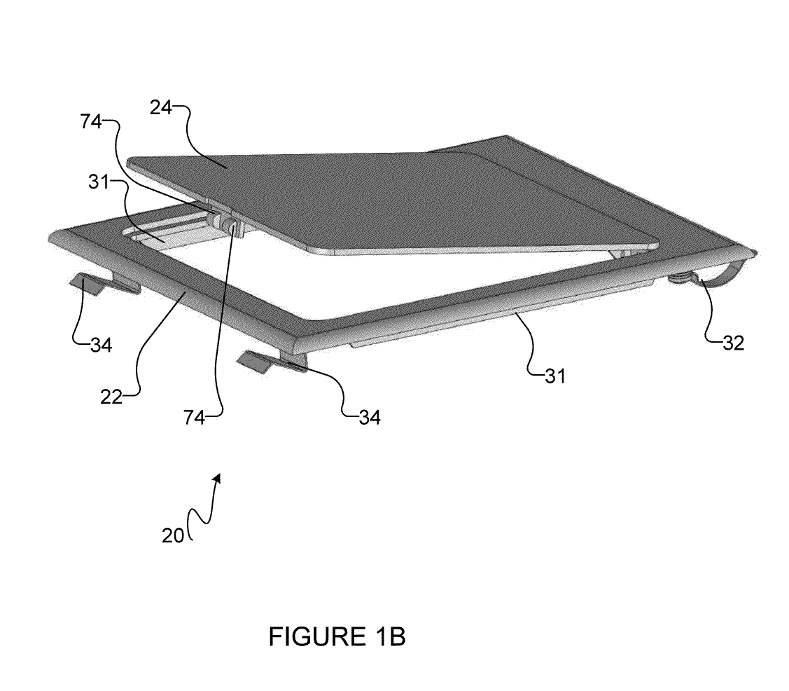

In order to secure frame 22 in an opening 29 in a construction surface 30 (FIG. 2), a plurality of clips are provided on frame 22. The clips are configured so that, in the installed configuration, a portion of the construction supporting construction surface 30, or a portion of construction surface 30 itself, referred to herein as a clamping surface 33, interposes the clips and frame 22, so that the clips secure frame 22 in place in opening 29.

As best seen in the embodiment illustrated in FIGS. 1B and 1C in which elements that correspond with elements shown in the embodiment of FIG. 1A are shown with the same reference numeral, mounting flanges 31 are provided on the upper and lower edges of frame 22 to support frame 22 in the vertical direction. Mounting flanges 31 project generally away from frame 22 horizontally into opening 29, so that mounting flanges 31 can contact the upper and lower edges of opening 29 to secure frame 22 in the vertical direction.

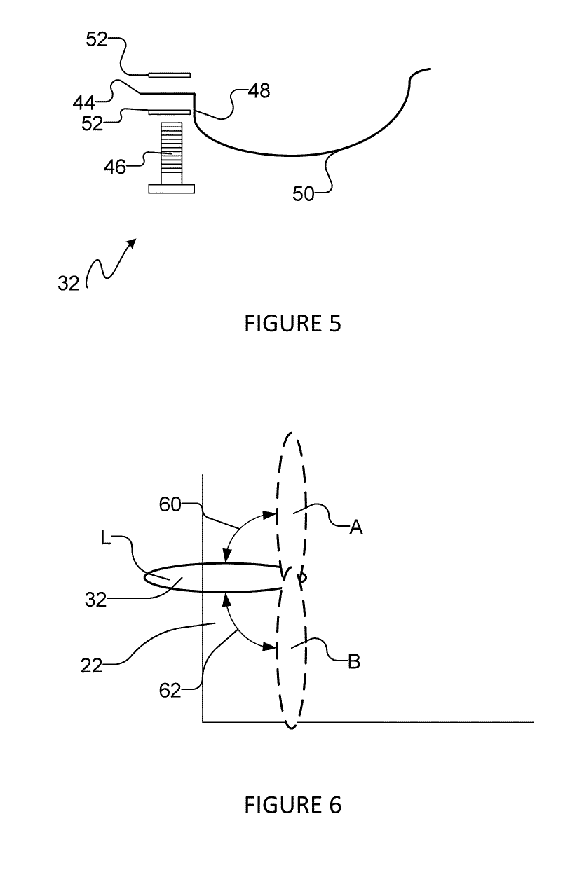

To facilitate installation of access door 20, the clips along at least one edge of access door 20 are rotatable between an insert position, wherein the clips do not project outwardly to such an extent that they interfere appreciably with a user sliding frame 22 into an installed position in opening 29, and a lock position, wherein a clamping surface 33 interposes the clip and frame 22 to hold frame 22 in the installed position. The insert and lock positions are described in greater detail with reference to FIG. 6 below.

In the illustrated embodiment, four clips are provided on frame 22 to hold frame 22 in the installed position. A pair of rotatable clips 32 are provided proximate adjacent corners 23A, 23B of frame 22, and a pair of fixed clips 34 are provided proximate the other two corners 23C, 23D of frame 22. The adjacent corners 23A, 23B are on a first edge 21A of frame 22. The adjacent corners 23C, 23D are on a second edge 21C of frame 22, opposite to the first edge 21A. Fixed clips 34 have a fixed position (i.e. cannot be rotated). Rotatable clips 32 are rotatable about an axis perpendicular to the plane of frame 22.

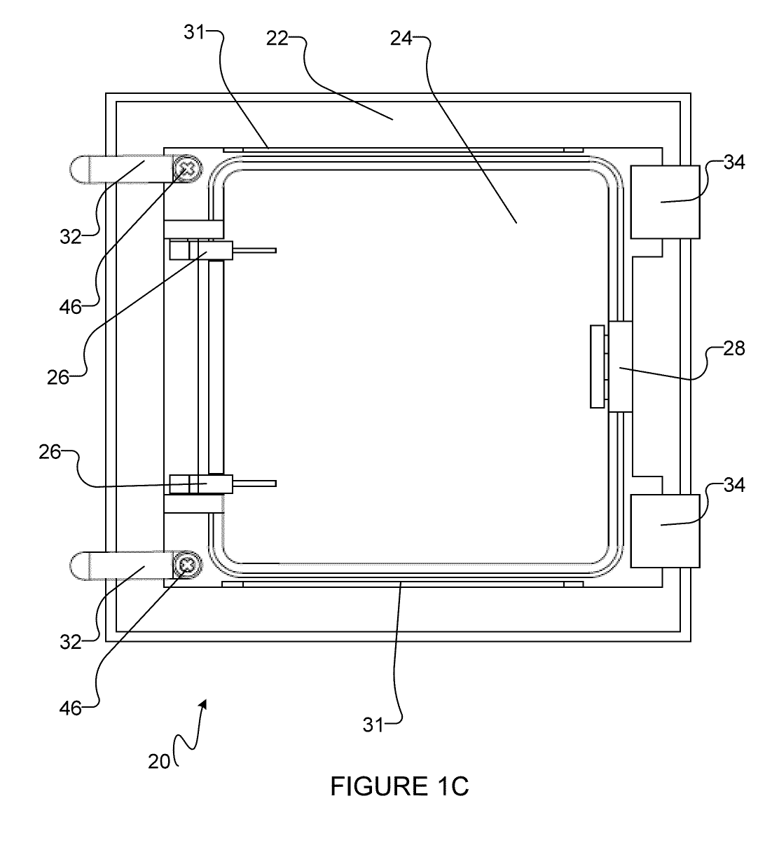

With reference to FIG. 3, in the illustrated embodiment, fixed clips 34 have a base 36 that can be secured to frame 22, a spacing portion 38 that extends generally perpendicularly from the base 36, and a clamping portion 40 that engages with the clamping surface 33 of the construction element to which clip 34 is secured, the clamping portion 40 extending generally perpendicularly or at a slightly acute angle from spacing portion 38. Clamping portion 40 projects outwardly from base 36, to receive a clamping surface 33 of a construction element between frame 22 and clamping portion 40. In the illustrated embodiment, the outer end of clamping portion 40 is provided with a deflected tip 42, which can facilitate insertion of a construction element between clip 34 and frame 22. In the illustrated embodiment, deflected tip 42 is bent in a direction away from base 36, which may make it easier for a user to slide clip 34 over clamping surface 33.

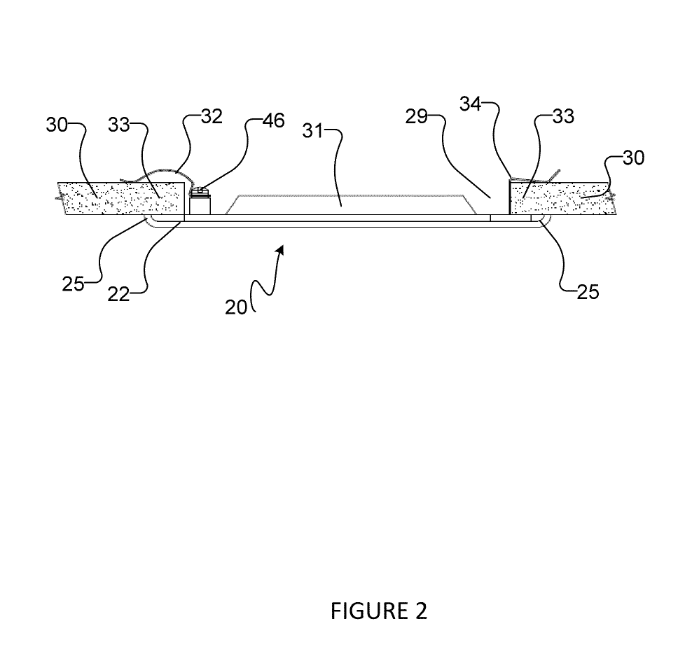

Any suitable clip that can be used to secure frame 22 to a construction element forming or supporting part of construction surface 30 may be used in place of clip 34. For example, with reference to FIG. 4, in an alternative embodiment in which parts that perform a similar function have been illustrated with reference numerals incremented by 100, fixed clip 134 has a base 136 with an aperture for receiving a threaded fastener 137 that is used to secure fixed clip 134 in place on frame 22. Fixed clip 134 also has a spacing portion 138 that is relatively shorter than spacing portion 38 of fixed clip 34, since fastener 137 spaces fixed clip 134 a small distance away from frame 22 in use. A clamping portion 140 extends outwardly from spacing portion 138 so that a clamping surface 33 can be received and held between clamping portion 140 and frame 22. Clamping portion 140 also includes a deflected tip 142, which may facilitate insertion of clamping surface 33 into fixed clip 134 in the same manner as described for deflected tip 42. In some embodiments, deflected tip 42 or deflected tip 142 is omitted.

In some embodiments, one or both of fixed clips 34 could be replaced by rotatable clips such as clips 32. In some embodiments, a single fixed clip 34 could be used on edge 21C of frame 22 to hold access door 20 in place. In some such embodiments, the single fixed clip 34 is provided near the middle of edge 21C rather than proximate one of corners 23C or 23D. In some embodiments, three or more fixed clips 34 could be provided on edge 21C.

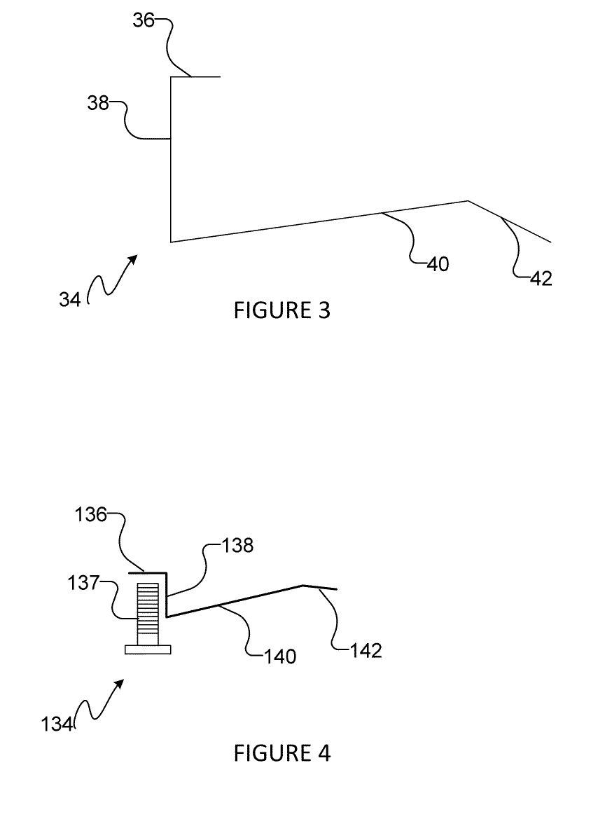

With reference to FIG. 5, in the illustrated embodiment, rotatable clips 32 have a base 44 that is secured to frame 22 with a suitable fastener, which is a threaded fastener 46 in the illustrated embodiment. A spacing portion 48 extends from base 44 in a direction generally perpendicular thereto and supports a curved clamping portion 50. Curved clamping portion 50 extends outwardly from spacing portion 48 so that a clamping surface 33 can be received and held between curved clamping portion 50 and frame 22 to secure access door 20 in the installed position. In some embodiments, washers 52 are provided for use with threaded fastener 46 to help secure rotatable clips 32 in place. While clamping portion 50 has been shown as curved in the illustrated embodiment, it will be clear to one skilled in the art that other shapes, for example a straight shape as used for fixed clip 34 described above, could be used, so that rotatable clip 32 can be used to secure a clamping surface 33 against frame 22. In some embodiments, a curved shape as illustrated for clamping portion 50 may be desirable because it is easy for a user to grasp and there are no sharp corners that might catch.

Clips 32, 34 are resilient so that they can be passed over clamping surface 33 and engage therewith to hold access door 20 in the installed position. Any suitable material may be used to make clips 32, 34. In some embodiments, clips 32, 34 are made from metal, for example, spring steel, galvanized spring steel, stainless steel, powder coated steel, galvanized steel, or plastic coated steel. In some embodiments, clips 32, 34 are coated with a rust inhibitive coating. In some embodiments, clips 32, 34 are made from any suitable type of plastic. In some embodiments, clips 32, 34 are independently made from different materials.

FIG. 6 illustrates schematically the insert and lock positions of a rotatable clip, shown schematically as 32. Rotatable clip 32 illustrated in solid outline is in the lock position L. In the lock position L, rotatable clip 32 can engage with a clamping surface 33 (i.e. a portion of construction surface 30 or a portion of the structure supporting construction surface 30, not shown in FIG. 6 for clarity) to hold access door 20 in the installed configuration.

As indicated by arrows 60, 62 in FIG. 6, rotatable clip 32 is rotatable about an axis perpendicular to the plane of frame 22 from the lock position L to an insert position, indicated in dotted outline as A and B. In the insert position, rotatable clip 32 is positioned to move without interference (or with only a very small degree of interference) past clamping surface 33 when frame 22 is inserted into opening 29. This allows frame 22 to be easily fitted into the installed configuration within opening 29, without rotatable clip 32 interfering with the insertion of frame 22 past clamping surface 33.

In use, the illustrated embodiment of a clip-in access door is installed as follows. First, opening 29 is provided in a construction surface 30 (FIG. 2). Opening 29 is preferably sized to be slightly smaller than the outside edge of frame 22, so that frame 22 will entirely cover opening 29 without leaving any gaps. A clamping surface 33 is provided on at least a portion of opening 29, to receive clips 32, 34. In the illustrated embodiment, construction surface 30 is a portion of drywall, and clamping surface 33 is provided by a portion of the drywall itself, i.e. access door 20 is clipped directly to the drywall surrounding opening 29. In other embodiments, clamping surface 33 is plywood, paneling, or the like, or any construction surface suitable for engagement with clips 32, 34.

In the illustrated embodiment, frame 22 is inserted into opening 29 at an elevation such that the top and bottom mounting flanges 31 contact the upper and lower edges of opening 29, respectively, to secure frame 22 in the vertical direction. With reference to the embodiment illustrated in FIG. 1A, a first edge 21C of frame 22 bearing fixed clips 34 is clipped to clamping surface 33 on a corresponding first edge of opening 29 by inserting access door 20 into opening 29 at a gentle angle with respect to construction surface 30. In this manner, deflected tips 42 of fixed clips 34 guide clamping surface 33 into fixed clips 34, so that clamping surface 33 is received between frame 22 and clamping portion 40 of fixed clip 34. The first edge 21C of frame 22 is thus secured into the installed position with respect to the corresponding first edge of opening 29 by engagement of fixed clips 34 with clamping surface 33 to hold clamping surface 33 against frame 22.

With rotatable clips 32 in the insert position (e.g. position A or B in FIG. 6), a second edge 21A of frame 22 bearing rotatable clips 32 is slid into the installed position with respect to a corresponding second edge of opening 29. The curved clamping portions 50 of rotatable clips 32 are thus slid past clamping surface 33 of construction surface 30 without substantially interfering with the installation of access door 20. In the illustrated embodiment of FIG. 1A, there are no clips projecting past third and fourth edges 21B and 21D of frame 22, and so these third and fourth edges can be readily slid into position past corresponding third and fourth edges of opening 29.

After frame 22 has been placed into the installed position, rotatable clips 32 are rotated to the lock position (e.g. position L shown in solid outline in FIG. 6), so that clamping surface 33 is securely received between curved clamping portion 50 and frame 22. Frame 22 is thereby secured in the installed position, and is securely retained in place by clips 32, 34, allowing door 24 to be opened and closed by a user by releasing and securing securing mechanism 28.

In some embodiments, rotatable clips 32 are manually rotated to the lock position by a user grasping clip 32 and rotating it to a desired position. In some embodiments, rotatable clips 32 are fixedly connected to threaded fasteners such as fasteners 46 so that the clamping portion (e.g. curved clamping portion 50) of rotatable clip 32 can be rotated to the lock position by a user rotating threaded fastener 46 to place rotatable clip 32 in the lock position.

To remove access door 20, for example to facilitate wall papering of construction surface 30 or to remove access door 20 for re-use in the event the building containing access door 20 is torn down or modified, the reverse procedure is followed. Rotatable clips 32 are rotated from the lock position L to the insert position (e.g. to positions A or B shown in FIG. 6). The second edge 21A of frame 22 bearing rotatable clips 32 is pulled gently away from the corresponding edge of opening 29 in construction surface 30, without substantial interference by rotatable clips 32. Fixed clips 34 can then be removed from clamping surface 33 by pulling access door 20 laterally away from clamping surface 33 at a small angle relative to construction surface 30 to remove access door 20 fully from opening 29.

While rotatable clips 32 have been described with reference to FIG. 6 as being rotatable between an insert position (e.g. A or B) and a lock position (e.g. L) wherein there is approximately a 90° rotation between the insert and lock positions, it will be apparent to one skilled in the art that rotatable clips 32 could be provided with a lesser or greater range of movement, e.g. 60°, 180° or 360°, so long as rotatable clips 32 are movable between an insert position, where the clamping portion of the clip (e.g. curved clamping portion 50) can be slid past clamping surface 33 without substantial interference, and a lock position, where the clamping portion (e.g. curved clamping portion 50) can retain clamping surface 33 against frame 22.

In the illustrated embodiment, rotatable clips 32 have been provided proximate adjacent corners on the left-hand side of access door 20. Rotatable clips 32 could alternatively be provided proximate any two adjacent corners of access door 20, e.g. on the top corners, bottom corners, or adjacent corners on the right-hand side of access door 20. In some embodiments, rotatable clips 32 are provided on three corners of frame 22, or on all four corners of frame 22.

While the illustrated embodiment has been described as having two rotatable clips 32, it will be apparent to one skilled in the art that the number and position of rotatable clips 32 used could be varied. For example, in some embodiments, only one rotatable clip 32 is provided on edge 21A of frame 22. In some such embodiments, rotatable clip 32 is positioned near the centre of edge 21A, instead of being positioned near corners 23A, 23B of frame 22. In some embodiments, three or more rotatable clips are provided on edge 21A. In some embodiments, rotatable clips are also provided on third and/or fourth edges 21B and/or 21D of frame 22. In some embodiments, rotatable clips are provided on edge 21C of frame 22 instead of or in addition to fixed clips 34. In some embodiments, rotatable clips are provided on any three edges (e.g. 21A, 21B and 21C; 21A, 21C and 21D; 21A, 21B and 21D; or 21B, 21C and 21D) or on all four edges (i.e. 21A, 21B, 21C and 21D) of frame 22. In some embodiments, clips could be provided on any two adjacent edges of frame 22, with the clips on at least one edge being rotatable clips, although such embodiments may not hold access door 20 as securely in place as embodiments in which at least one clip is provided on each of two opposite sides of frame 22.

While a specific embodiment of a rotatable clip 32 has been described and illustrated, other structures of rotatable clip can be used, so long as such rotatable clips can be rotated between an insert position, allowing relatively easy insertion of frame 22 into the installed position without substantial interference by the clip, and a lock position securing access door 20 to clamping surface 33.

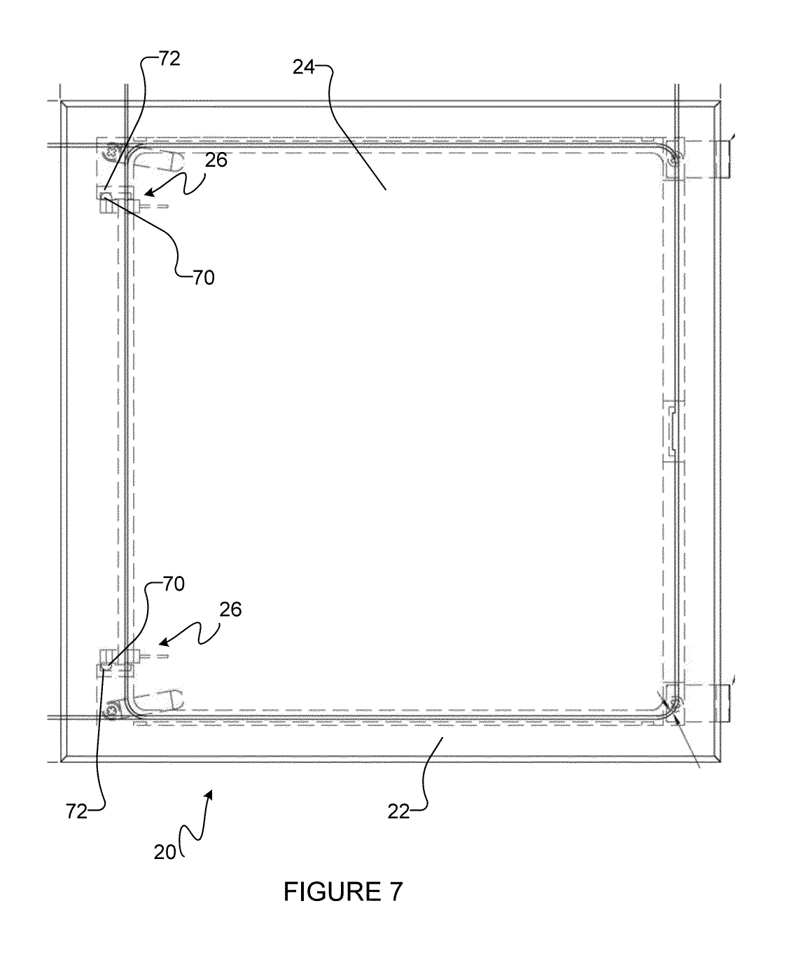

With respect to hinges 26, any suitable mechanism that allows door 24 to be opened relative to frame 22 to provide access through opening 29 can be used. With reference to FIG. 7, in the illustrated embodiment, hinges 26 comprise a pair of projections 70 formed on a first edge of door 24 that are engaged with a corresponding pair of receptacles 72 formed on a corresponding edge of frame 22 to allow rotational movement of door 24 relative to frame 22. Other suitable hinges could be used, for example a piano hinge could be affixed to both frame 22 and door 24, or could be embedded in the plastic of either frame 22 or door 24 and the affixed to door 24 or frame 22, respectively.

With respect to securing mechanism 28, any suitable latch or locking mechanism that can be secured to hold door 24 in a closed position with respect to frame 22 and released to allow door 24 to move to an open position with respect to frame 22 can be used. In the illustrated embodiment, securing mechanism 28 comprises a projection 74 (FIG. 1B) formed on door 24 that engages with a corresponding receptacle formed in edge 21C of frame 22. In other embodiments, a hole is provided in door 24 to receive a latching mechanism that can engage with a suitably sized and positioned aperture between frame 22 and clamping surface 33, for example a cylinder key lock, an Allen (hex) key cylinder cam latch, or a non-locking two-position handle could be used to releasably secure door 24 in the closed position with respect to frame 22.

In the illustrated embodiment, the outer edges of frame 22 are curved (curvature shown as 25 in FIG. 2). The outer edges are curved so that when access door 20 is in the installed configuration, the outer edges of frame 22 curve gently towards construction surface 30. Providing a curved outer edge of frame 22 can add stiffness to frame 22 and may also enhance the appearance and feel of frame 22. However, it will be apparent to one skilled in the art that the outer edge of frame 22 could be provided with any desired configuration, and could be made flat in some embodiments.

Any suitable materials may be used to manufacture access door 20. In some embodiments, frame 22 and door 24 are manufactured from plastic. Any other suitable material may be used to manufacture frame 22 and door 24, for example wood or metal (e.g. steel), and frame 22 and door 24 can independently be manufactured from different materials.

While a number of exemplary aspects and embodiments have been discussed above, those of skill in the art will recognize certain modifications, permutations, additions and sub-combinations thereof. For example:
While an exemplary embodiment has been described with reference to a square or rectangular access door, it will be apparent to one skilled in the art that the shape of the access door could be varied, for example made circular, triangular, pentagonal or other polygonal shape, of custom shape, or the like, by providing a frame and an opening of the appropriate shape and by providing a sufficient number of fixed and rotatable clips to allow the access door to be readily slid into place for installation and clipped in the installed position.
Top and/or bottom mounting flanges 31 could be omitted. For example, provision of only a bottom mounting flange 31 could be sufficient to support access door 20 in the vertical direction in some embodiments. In some embodiments, clips 32, 34 could engage clamping surface 33 sufficiently well that top and/or bottom mounting flanges 31 are not required. In embodiments mounted in ceilings or other structures where the access door is mounted in a horizontal rather than vertical orientation, no mounting flanges would be required to restrain the access door in the vertical direction, although these might optionally be provided to resist movement of the access door in certain horizontal directions, depending on the placement of clips 32, 34.
   It is therefore intended that the following appended claims and claims hereafter introduced are to be given the broadest interpretation consistent with the specification as a whole.

What is claimed is:

1. A clip-in access door for covering an opening in a construction surface, the access door comprising:
a frame for mounting in the opening;
a door mounted on the frame, the door being movable between a closed position covering the opening and an open position allowing at least partial access through the opening; and
a plurality of clips mounted on the frame for securing the frame in the opening, the clips along at least one edge of the frame comprising rotatable clips being rotatable between an insert position allowing the frame to be inserted fully into the opening without substantial interference by the rotatable clips and a lock position securing the frame in the opening.

2. A clip-in access door as defined in claim 1, comprising a securing mechanism engageable with the frame and with the door to releasably secure the door in the closed position.

3. A clip-in access door as defined in claim 1, wherein the plurality of clips comprises four clips, each one of the clips being mounted adjacent to one of the corners of the frame, at least two of the clips comprising rotatable clips.

4. A clip-in access door as defined in claim 3, wherein the plurality of clips comprises three rotatable clips or four rotatable clips.

5. A clip-in access door as defined in claim 1, comprising top and/or bottom mounting flanges provided on the top and/or bottom edges of the frame.

6. A clip-in access door as defined in claim 5, wherein the mounting flange comprises an inwardly extending projection configured to contact at least a portion of the construction surface.

7. A clip-in access door as defined in claim 1, wherein the rotatable clips comprise a curved clamping portion for engaging a clamping surface of the construction surface against the frame.

8. A clip-in access door as defined in claim 7, wherein the rotatable clips comprise a base for engaging with the frame, and a spacing portion extending generally perpendicularly from the base, the clamping portion being engaged with and projecting outwardly from the spacing portion so that the clamping portion is spaced apart from the frame so that the clamping surface of the construction surface can be received between the frame and the clamping portion.

9. A clip-in access door for covering an opening in a construction surface, the access door comprising:
a frame for mounting in the opening;
a door mounted on the frame, the door being movable between a closed position covering the opening and an open position allowing at least partial access through the opening; and
at least two clips mounted on the frame for securing the frame in the opening, a first one of the at least two clips being mounted on a first edge of the frame and comprising a fixed clip, and a second one of the at least two clips being mounted on a second edge of the frame opposite the first edge and comprising a rotatable clip being rotatable between an insert position allowing the frame to be inserted fully into the opening without substantial interference by the rotatable clips and a lock position securing the frame in the opening.

10. A clip-in access door as defined in claim 9, comprising a securing mechanism engageable with the frame and with the door to releasably secure the door in the closed position.

11. A clip-in access door as defined in claim 9, wherein two fixed clips are mounted on the first edge of the frame and two rotatable clips are mounted on the second edge of the frame, each one of the clips being mounted adjacent to one of the corners of the frame.

12. A clip-in access door as defined in claim 9, comprising top and/or bottom mounting flanges provided on the top and/or bottom edges of the frame.

13. A clip-in access door as defined in claim 12, wherein the mounting flange comprises an inwardly extending projection configured to contact at least a portion of the construction surface.

14. A clip-in access door as defined in claim 9, wherein the rotatable clip comprises a curved clamping portion for engaging a clamping surface of the construction surface against the frame.

15. A clip-in access door as defined in claim 14, wherein the rotatable clip comprises a base for engaging with the frame, and a spacing portion extending generally perpendicularly from the base, the clamping portion being engaged with and projecting outwardly from the spacing portion so that the clamping portion is spaced apart from the frame so that the clamping surface of the construction surface can be received between the frame and the clamping portion.

16. A clip-in access door as defined in claims 9, wherein the fixed clip is not rotatable and comprises a base for engaging with the frame, a spacing portion extending generally perpendicularly from the base, and a clamping portion projecting outwardly from the spacing portion to receive a clamping surface of the construction surface between the clamping portion and the frame.

17. A clip-in access door as defined in claim 14, wherein the curved clamping portion of the rotatable clip comprises a deflected tip.

18. A clip-in access door as defined in claim 16, wherein the clamping portion of the fixed clip comprises a deflected tip.

19. A method of installing a clip-in access door in an opening in a construction surface, the method comprising:
inserting a first edge of a frame of the access door bearing at least one clip over a clamping surface of a corresponding first edge of the opening so that the clip engages with the clamping surface;
inserting a second edge of the frame of the access door bearing at least one rotatable clip over a clamping surface on a corresponding second edge of the opening, with the rotatable clip being rotated to an insert position; and
rotating the rotatable clip from the insert position to a lock position so that the rotatable clip engages a clamping surface on the second edge of the opening to secure the clip-in access door in an installed position.

20. A method as defined in claim 19, wherein the at least one clip of the first edge of the frame comprises a fixed clip.
